(19) United States
(12) Patent Application Publication
(10) Pub. No.: US 2012/0158957 A1
(43) Pub. Date: Jun. 21, 2012

(54) RELAY APPARATUS AND COMMUNICATION METHOD

(75) Inventors: Shotaro NAKAYAMA, Kawasaki (JP); Masanori NAGANUMA, Kawasaki (JP); Takashi SAWAKURI, Kawasaki (JP); Shigeki SEKINE, Kawasaki (JP)

(73) Assignee: FUJITSU LIMITED, Kawasaki-shi (JP)

(21) Appl. No.: 13/326,424

(22) Filed: Dec. 15, 2011

(30) Foreign Application Priority Data
Dec. 20, 2010 (JP) 2010-283361

(51) Int. Cl. G06F 15/173

(52) U.S. Cl. 709/224

(57) ABSTRACT

A relay apparatus performing communication between a first processing apparatus and a second processing apparatus through another relay apparatus, the relay apparatus includes a transmission unit to transmit transmission data to the other relay apparatus, a calculation unit to measure a round trip time (RTT) from transmission of data to the other relay apparatus to receiving of a response, and calculate a transmission time on a basis of the RTT, and a scheduler unit to control transmission times of transmission data to the other relay apparatus outputs, when the scheduler unit detects the transmission data and a size of the detected transmission data is not larger than a specified value, the transmission data to the transmission unit after a time from the detection of the transmission data has passed the transmission time.

### CROSS-REFERENCE TO RELATED APPLICATION

This application is based upon and claims the benefit of priority of the prior Japanese Patent Application No. 2010-283361, filed on Dec. 20, 2010, the entire contents of which are incorporated herein by reference.

### FIELD

The embodiments discussed herein are related to a relay apparatus and a method of data communication between relay apparatuses.

### BACKGROUND

It is customary to extend a communication path between a host and an input/output (IO) device using an extension apparatus in order to extend a physical distance between the host and the IO device.

In a channel extension system 11 illustrated in FIG. 1, a host 12 and a channel extension apparatus 13 are connected through a channel interface, the channel extension apparatus 13 and a channel extension apparatus 14 are connected through a network 16, and the channel extension apparatus 14 and an IO device 15 are connected through a channel interface.

In data transfer between the host 12 and the IO device 15 connected through the channel extension apparatuses 13 and 14, communication is performed using a connection-oriented transport protocol.

In the connection-oriented transport protocol, a transfer-efficiency improvement algorithm is used in general. For example, in Transmission Control Protocol (TCP), the Nagle algorithm and a delayed acknowledgment (Delayed ACK) algorithm are used.

In the Nagle algorithm, data transmission is performed at any one of the following times: (1) A size of transmission data becomes a maximum segment size (MSS) or more; (2) an acknowledgment of previous data transmission is received; and (3) a specified period of time (for example, 200 milliseconds) has passed since detection of transmission data.

That is to say, when one piece of data not larger than the MSS is transmitted, transmission is delayed for a specified period of time.

In general, a “specified time period” in a transfer-efficiency improvement algorithm, that is to say, transmission waiting time is set greater than a network delay. For example, while the transmission waiting time of the Nagle algorithm in TCP is generally set to 200 milliseconds, a network delay in a practical level (in Japan) is 50 milliseconds at a maximum.

Related arts are disclosed in Japanese Laid-open Patent Publication No. 2006-129487 and Japanese Laid-open Patent Publication No. 2000-278320.

In data transmission and receiving between a host and an IO device, small-sized data having a data size not larger than an MSS and large-sized data having a data size not smaller than the MSS are mixed together. For example, if it is assumed that the IO device is a tape unit, when data is written into the tape unit, control commands and statuses are transmitted between the host and the IO device before and after writing tape data.

When a control command is transferred between channel extension apparatuses, the control command becomes not larger than the MSS in size. Also, every time an IO device completes processing, the IO device returns a status to a host. When a status is transferred between channel extension apparatuses, a data size of the status becomes not larger than the MSS.

In data communication between channel extension apparatuses, if an existing transfer efficiency improvement algorithm, such as the Nagle algorithm, is used, there has been a problem in that a delay occurs more than necessary at the time of transmitting small-sized data. Thereby, there has been a problem in that transfer performance is deteriorated in the entire channel extension system.

Also, if a transfer efficiency improvement algorithm is not used, a transmission interval becomes 0, and thus there is a problem in that small-sized data often occurs on a network, resulting in network congestion. Also, fragmentary data might be transmitted, and thus there is a problem in that transfer efficiency decreases at the time of transmitting large-sized data.

### SUMMARY

A relay apparatus performing communication between a first processing apparatus and a second processing apparatus through another relay apparatus, the relay apparatus includes a transmission unit to transmit transmission data to the other relay apparatus, a calculation unit to measure a round trip time (RTT) from transmission of data to the other relay apparatus to receiving of a response, and calculate a transmission time on a basis of the RTT, and a scheduler unit to control transmission times of transmission data to the other relay apparatus outputs, when the scheduler unit detects the transmission data and a size of the detected transmission data is not larger than a specified value, the transmission data to the transmission unit after a time from the detection of the transmission data has passed the transmission time.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of a related-art channel extension system.

FIG. 2 is a configuration diagram of a channel extension system according to an embodiment.

FIG. 3 is a configuration diagram of a channel extension apparatus according to an embodiment.

FIG. 4 is a configuration diagram of a transport-protocol processing unit according to an embodiment.

FIG. 5 is an example of a global table.

FIG. 6 is an example of an RTT recording table.

FIG. 7 is a flowchart of RTT-measurement-packet transmission processing according to an embodiment.

FIG. 8 is a flowchart of RTT calculation processing according to an embodiment.

FIG. 9 is a flowchart of transmission processing according to an embodiment.

FIG. 10 is a sequence diagram of data writing according to an embodiment.

### DESCRIPTION OF EMBODIMENTS

In the following, a description will be given of an embodiment with reference to the drawings.

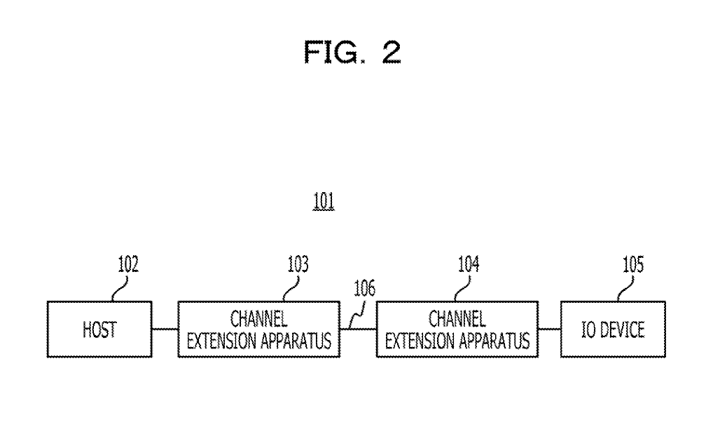

FIG. 2 is a configuration diagram of a channel extension system according to the embodiment.

The channel extension system 101 includes a host 102, channel extension apparatuses 103 and 104, and an input/output (IO) device 105.

The host 102 and the IO device 105 are examples of processing apparatuses.

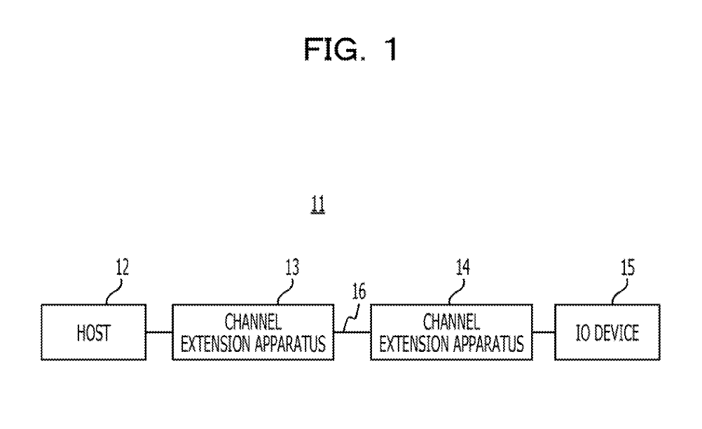

The channel extension apparatuses 103 and 104 are examples of relay apparatuses. The channel extension apparatuses 103 and 104 operate in a different manner compared to the channel extension apparatuses 13 and 14 illustrated in FIG. 1. Details about the channel extension apparatuses 103 and 104 will be described below.

The host 102 is an information processing apparatus that makes a data input/output request to the IO device 105.

The host 102 is connected to the extension apparatus 103 through a channel interface. The channel interface is, for example, an electric channel (block multiplexer channel (BMC)) or an optical channel (optical channel link (OCLINK)).

The channel extension apparatus 103 operates as a pseudo-IO device for the host 102. The channel extension apparatus 103 is connected to the channel extension apparatus 104 through a network 106. The network 106 is, for example, a local area network (LAN), and a wide area network (WAN).

Internet Protocol (IP) connection is used between the channel extension apparatuses 103 and 104, and the channel extension apparatuses 103 and 104 perform communication using a connection-oriented transport protocol in order to increase data transmission to a transmission-destination channel extension apparatus.

The channel extension apparatus 104 is connected to the IO device 105 through a channel interface. The channel extension apparatus 104 operates as a pseudo host for the IO device 105.

The channel extension apparatuses 103 and 104 relay data between the host 102 and the IO device 105.

The IO device 105 inputs data from the host 102, and outputs data to the host 102. The IO device 105 is, for example, a tape unit, a magnetic disk unit, or a printer, etc.

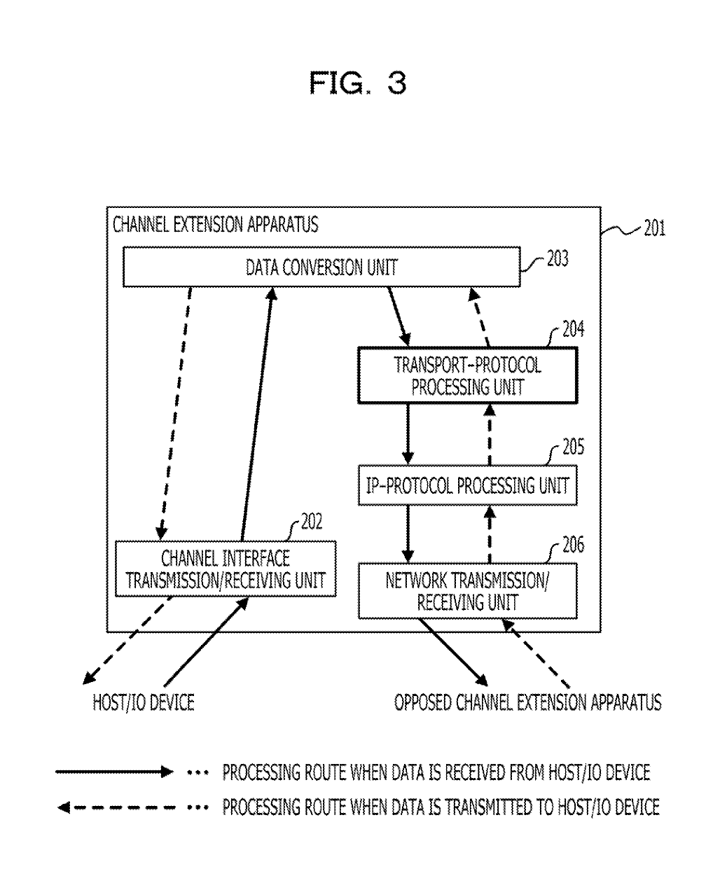

FIG. 3 is a configuration diagram of a channel extension apparatus according to the embodiment.

A channel extension apparatus 201 includes a channel interface transmission/receiving unit 202, a data conversion unit 203, a transport-protocol processing unit 204, an IP-protocol processing unit 205, and a network transmission-and-receiving unit 206. The channel extension apparatus 201 illustrated in FIG. 3 has a CPU (Central Processing Unit), which is not illustrated in the figure, and a storage device, such as a memory, a hard disk drive (HDD), etc., which are not illustrated in the figure. The processing performed by the channel extension apparatus 201, described below, is executed by the CPU. Also, data read and output by the channel extension apparatus 201 and data recorded in various tables are stored in the storage device, such as the memory, the HDD, etc., not illustrated in the figure.

In this regard, the channel extension apparatus 201 corresponds to the channel extension apparatuses 103 and 104 in FIG. 2.

The channel interface transmission/receiving unit 202 transmits data received from the data conversion unit 203 to the host 102 or the IO device 105, and transmits data received from the host 102 or the IO device 105 to the data conversion unit 203.

The data conversion unit 203 performs protocol conversion between the channel interface and the network. The data conversion unit 203 receives data from the channel interface transmission/receiving unit 202 or the transport-protocol processing unit 204, performs protocol conversion, and transmits the converted data to the transport-protocol processing unit 204 or the channel interface transmission/receiving unit 202.

The transport-protocol processing unit 204 performs measurement of a round trip time (RTT) and control of transmission times of data, etc., on a basis of the RTT. The RTT is time from transmission of data to a destination until receiving of its acknowledgment (ACK) from the transmission destination.

A reason for using an RTT in the embodiment is as follows.

The RTT is a threshold time for confirmation of data transmission to a sending party in a connection-oriented protocol. If data is transmitted in a shorter time than the RTT, it means that redundant data is transmitted, resulting in waste of limited network resources. Accordingly, avoiding the waste leads to reducing network congestion.

Also, the RTT is a value that changes depending on a distance to a sending party and performance of a communication-destination device. If a distance to the sending party is long, the RTT becomes large. On the contrary, if the distance is short, the RTT becomes small. If it is possible to transmit data with transmission times greater than an amount of RTT, the transmission timing is enhanced in accordance with a sending-party location.

In consideration of the above matters, in the embodiment, data transmission times based the RTT is employed as a method of enhancing transmission timing of small-sized data while reducing network congestion as much as possible.

The transport-protocol processing unit 204 receives data from the data conversion unit 203, and transmits the data to the IP-protocol processing unit 205, or receives data from the IP-protocol processing unit 205, and transmits the data to the data conversion unit 203.

The IP-protocol processing unit 205 adds an IP header to the transmission data, or deletes an IP header from the receive data. The IP-protocol processing unit 205 receives data from the transport-protocol processing unit 204, adds an IP header to the data, and transmits the data to the network transmission-and-receiving unit 206, or receives data from the network transmission-and-receiving unit 206, deletes an IP header from the data, and transmits the data to the transport-protocol processing unit 204.

The network transmission-and-receiving unit 206 transmits data input from the IP-protocol processing unit 205 to the opposed channel extension apparatus connected through the network 106, or receives data from the opposed channel extension apparatus and outputs the data to the IP-protocol processing unit 205.

A solid-line arrow in FIG. 3 illustrates a data processing route when data is received from the host 102 or the IO device 105, and a broken-line arrow illustrates a data processing route when data is transmitted to the host 102 or the IO device 105.

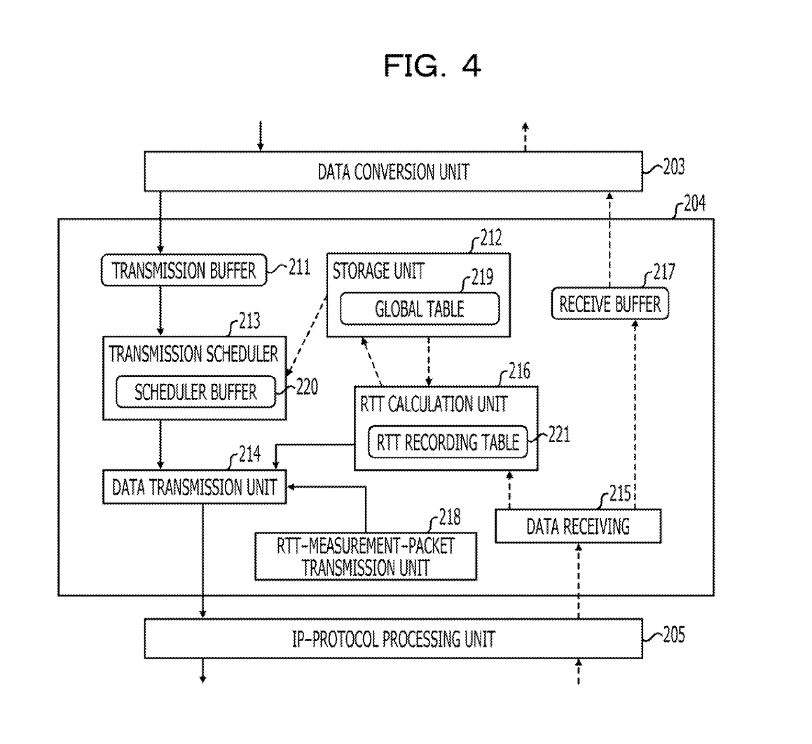

FIG. 4 is a configuration diagram of a transport-protocol processing unit according to the embodiment.

The transport-protocol processing unit 204 includes a transmission buffer 211, a storage unit 212, a transmission scheduler 213, a data transmission unit 214, a data receiving unit 215, an RTT calculation unit 216, a receive buffer 217, and an RTT-measurement-packet transmission unit 218.

The transmission buffer 211 is a buffer for temporarily storing transmission data received from the data conversion unit 203.

The storage unit 212 is a storage unit to store various kinds of data. The storage unit 212 uses a random access memory (RAM), for example. The storage unit 212 stores a global table 219. Allowable RTT values and average RTT values are written in the global table 219. In this regard, a detailed description will be given of the global table 219 later.

The transmission scheduler 213 performs data transmission on the basis of each data size, and performs data transmission at the timing based on the average RTT value. The transmission scheduler 213 includes a scheduler buffer 220. The transmission scheduler 213 reads data from the transmission buffer 211, and stores the data into the scheduler buffer 220. The transmission scheduler 213 suitably outputs the data of the scheduler buffer 220 to the data transmission unit 214.

The data transmission unit 214 outputs data input from the transmission scheduler 213, the RTT calculation unit 216, or the RTT-measurement-packet transmission unit 218 to the IP-protocol processing unit 205.

The data receiving unit 215 receives data from the IP-protocol processing unit 205, and outputs the data to the RTT calculation unit 216 or the receive buffer 217. If the received data is an RTT measurement packet, the data receiving unit 215 outputs the data to the RTT calculation unit 216, whereas if the received data is destined to the host 102 or to the IO device 105, the data receiving unit 215 outputs the data to the receive buffer 217.

The RTT calculation unit 216 has an RTT recording table 221. The RTT calculation unit 216 measures an RTT, and writes the RTT into the RTT recording table 221. The RTT calculation unit 216 calculates an average value of the RTTs, and writes the average RTT value into the global table 219.

The receive buffer 217 is a buffer for temporarily storing receive data received from the data receiving unit 215.

The RTT-measurement-packet transmission unit 218 outputs a packet (RTT measurement packet) for measuring an RTT to the data transmission unit 214.

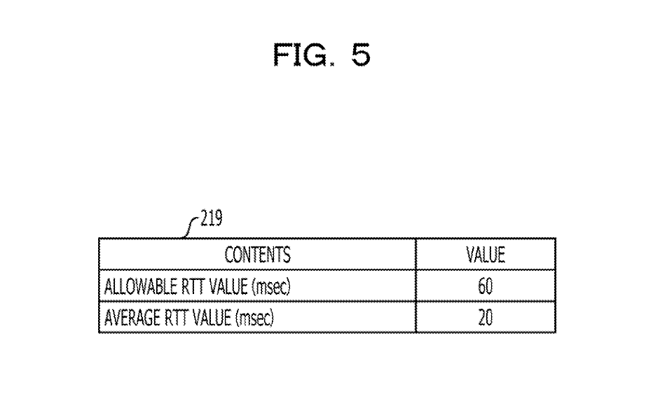

FIG. 5 is an example of the global table.

Allowable RTT values and average RU values are written into the global table 219. In this regard, an RTT value is measured in units of milliseconds.

The allowable RTT value indicates a maximum value of RTT measured values to be used for calculating an average RTT value. For the allowable RTT value, for example, an RTT asserted by a network carrier can be used. Also, an RTT at which temporal network congestion is empirically determined to occur can be used for an allowable RTT value.

The average RTT value is an average value of a specified number of RTTs. In this regard, a detailed description will be given of calculation of the average RTT value later.

For example, in the global table 219 in FIG. 5, the allowable RTT value is 60 (milliseconds), and the average RTT value is 20 (milliseconds).

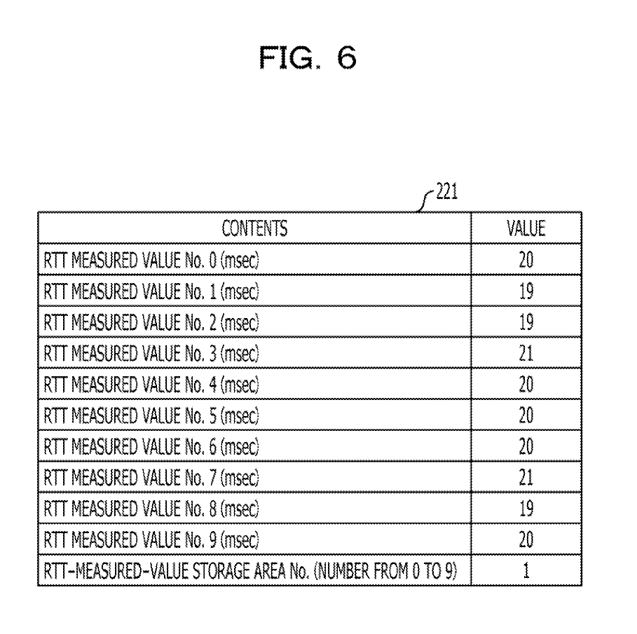

FIG. 6 is an example of the RTT recording table.

A plurality of RTT measured values and RTT-measured-value storage area Nos. are written in the RTT recording table 221.

The RTT measured value is an RTT measured by the RTT calculation unit 216.

In FIG. 6, 10 RTT measured values are written. One of numbers from No. 0 to No. 9 is assigned to a corresponding place in which each RTT measured value is written.

For example, in FIG. 6, an RTT measured value of the RTT measured value No. 0 is 20 (milliseconds).

An RTT-measured-value storage area No. indicates a place in which a measured RTT is written next. That is to say, the RTT-measured-value storage area No. indicates an unwritten RTT measured value No. or the oldest RTT measured value No.

In the embodiment, the RTT-measured-value storage area No. takes a number from 0 to 9, and wraps around at 9 to return to 0.

For example, in FIG. 6, the RTT-measured-value storage area No. is 1, and thus an RTT measured value measured next is overwritten in the place of the RTT measured value No. 1.

Next, a description will be given of measurement and management of the RTT.

First, a description will be given of transmission processing an RTT measurement packet for measuring an RTT.

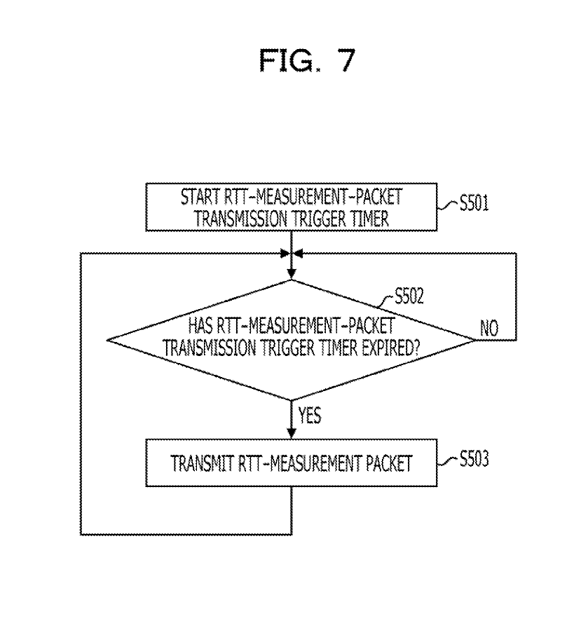

FIG. 7 is a flowchart of transmission processing of an RTT measurement packet according to the embodiment.

In S501, the RTT-measurement-packet transmission unit 218 starts an RTT-measurement-packet-transmission trigger timer. In this regard, the RTT-measurement-packet-transmission trigger timer is included in the RTT-measurement-packet transmission unit 218. The RTT-measurement-packet-transmission trigger timer expires in a specified time period (for example, 10 seconds).

In S502, the RTT-measurement-packet transmission unit 218 checks whether the RTT-measurement-packet-transmission trigger timer has expired. If the RTT-measurement-packet-transmission trigger timer has expired, the control proceeds to S503. If the RTT-measurement-packet-transmission trigger timer has not expired, the control returns to S502. In this regard, after the RTT-measurement-packet-transmission trigger timer has expired, the timer is reset, and again expires in the specified time period.

In S503, the RTT-measurement-packet transmission unit 218 transmits an RTT measurement packet to the data transmission unit 214. The RTT measurement packet includes a time of transmission and an identifier for identifying an extension apparatus that has transmitted the measurement packet. The RTT measurement packet is output from the data transmission unit 214 to the IP-protocol processing unit 205 and further is transmitted via the network transmission-and-receiving unit 206 to the channel extension apparatus connected through the network 16.

The RTT varies with a relay path of a network and a relay apparatus in the network, and thus the extension apparatus 204 according to the embodiment periodically transmits an RTT measurement packet to measure an RTT, and adopts an RTT at each occasion.

Next, a description will be given of measurement of an RTT and calculation of an average.

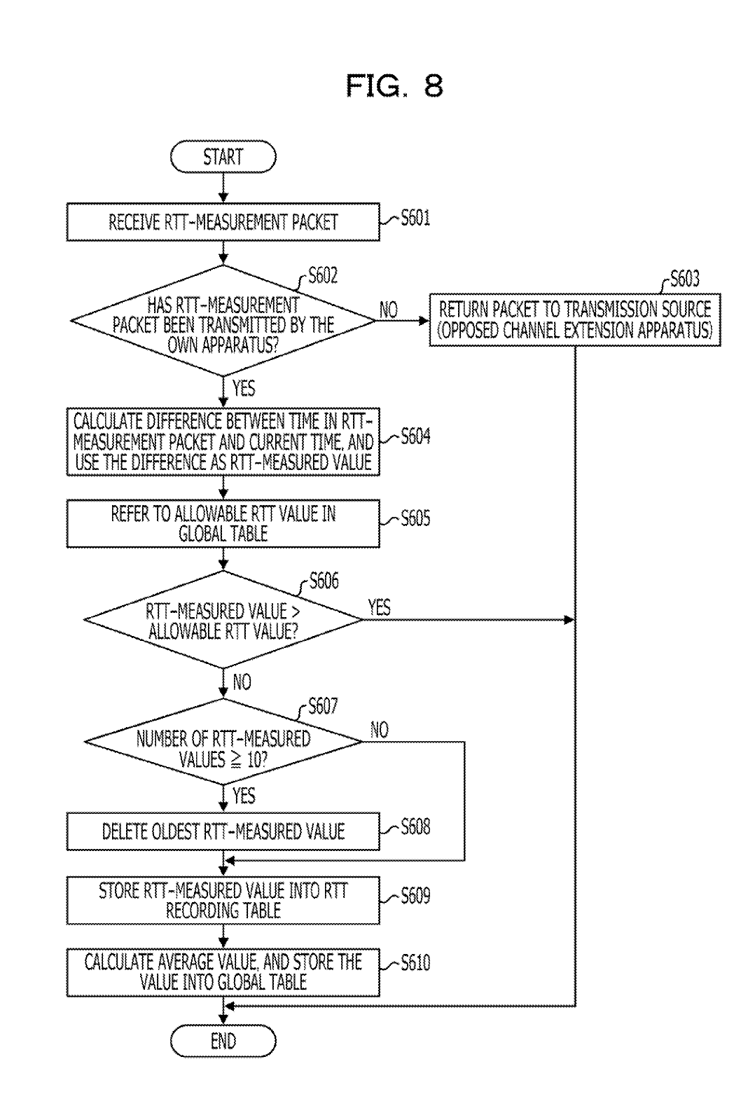

FIG. 8 is a flowchart of RTT calculation processing according to the embodiment.

In S601, the RTT calculation unit 216 receives an RTT measurement packet.

In S602, the RTT calculation unit 216 determines whether the received RTT measurement packet is a packet transmitted by the own apparatus or not, that is to say, whether the received RTT measurement packet is a packet that was sent by the own apparatus to another extension apparatus connected to the own apparatus in the past, and that has been returned from that extension apparatus. If the received RTT measurement packet is a packet that was transmitted by the own apparatus, the control proceeds to S604, whereas if it is not a packet that was transmitted by the own apparatus, the control proceeds to S603. Whether the received RTT measurement packet is a packet that was transmitted by the own apparatus or not is determined by an identifier described in the RTT measurement packet.

In S603, the RTT calculation unit 216 returns the received RTT measurement packet to a transmission source, that is to say, to the opposed channel extension apparatus.

In S604, the RTT calculation unit 216 calculates a difference between a time described in the RTT measurement packet and the current time, and determines the difference to be an RTT measured value.

In S605, the RTT calculation unit 216 refers to the global table 219, and reads an allowable RTT value.

In S606, the RTT calculation unit 216 determines whether the RTT measured value is greater than the allowable RTT. If the RTT measured value is greater than the allowable RTT, the processing terminates. If the RTT measured value is not greater than the allowable RTT, the control proceeds to S607.

In S607, the RTT calculation unit 216 determines whether a number of RTT measured values recorded in the RTT recording table 221 is not smaller than a threshold value. In the embodiment, the threshold value is assumed to be 10. If the number of RTT measured values is the threshold value or more, the control proceeds to S608, whereas if it is less than the threshold value, the control proceeds to S609.

In S608, the RTT calculation unit 216 deletes an oldest RTT measured value among the RTT measured values recorded in the RTT recording table 221.

In S609, the RTT calculation unit 216 writes the RTT measured value calculated in S604 in the RTT recording table 221.

In S610, the RTT calculation unit 216 calculates an average value of the RTT measured values recorded in the RTT recording table 221, and writes the average value into the global table 219 as an RTT average value.

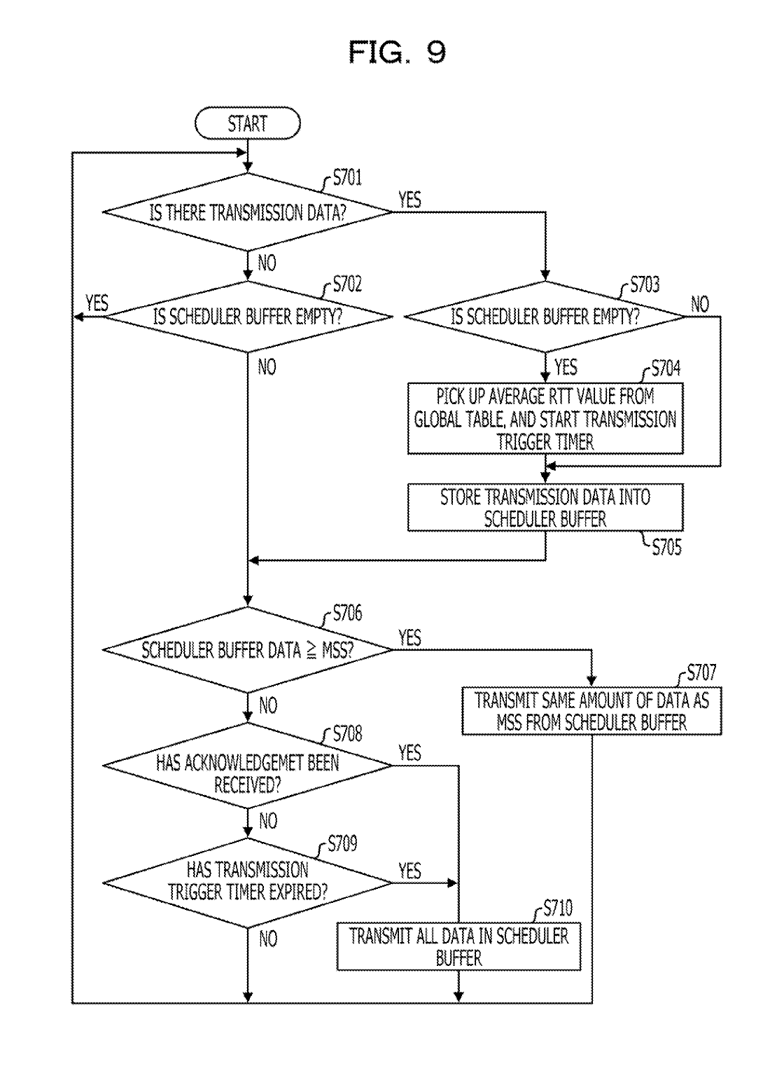

FIG. 9 is a flowchart of transmission processing according to the embodiment.

In S701, the transmission scheduler 213 checks whether there is transmission data in the transmission buffer 211. If there is transmission data, the control proceeds to S703, whereas if there is no transmission data, the control proceeds to S702.

In S702, the transmission scheduler 213 checks whether the scheduler buffer 220 is empty. If the scheduler buffer 220 is empty, the control returns to S701, whereas if the scheduler buffer 220 is not empty, the control proceeds to S706.

In S703, the transmission scheduler 213 checks whether the scheduler buffer 220 is empty. If the scheduler buffer 220 is empty, the control proceeds to S704, whereas if the scheduler buffer 220 is not empty, the control proceeds to S705.

In S704, the transmission scheduler 213 refers to the global table 219, and reads an RTT average value. The transmission scheduler 213 starts the transmission trigger timer, sets an expiration time of the transmission trigger timer to the RTT average value. Thereby, when a time period of the RTT average value has passes since the transmission trigger timer has been started, the transmission trigger timer expires. In this regard, the transmission trigger timer is included in the transmission scheduler 213.

In S705, the transmission scheduler 213 stores transmission data in the transmission buffer 211 into the scheduler buffer 220.

In S706, the transmission scheduler 213 determines whether a size of data stored in the scheduler buffer 220 is a maximum segment size (MSS) or more. If the size of the data in the scheduler buffer 220 is the MSS or more, the control proceeds to S708, whereas if it is less than the MSS, the control proceeds to S707. In this regard, the MSS is a maximum value of the transmission unit (segment) of data in TCP.

In S707, the transmission scheduler 213 outputs substantially a same amount of data as the MSS to the data transmission unit 214 from the data stored in the scheduler buffer 220.

In S708, the transmission scheduler 213 determines whether an acknowledgment has been received or not. If the acknowledgment has been received, the control proceeds to S710, whereas if the acknowledgment has not been received, the control proceeds to S709.

In this regard, the acknowledgment is a response to the data transmitted at previous time before the scheduler buffer 220 has become empty.

In S709, the transmission scheduler 213 checks whether the transmission trigger timer has expired. If the transmission trigger timer has expired, the control proceeds to S710. If the transmission trigger timer has not expired, the control returns to S701.

In S710, the transmission scheduler 213 outputs all the data stored in the scheduler buffer 220 to the data transmission unit 214.

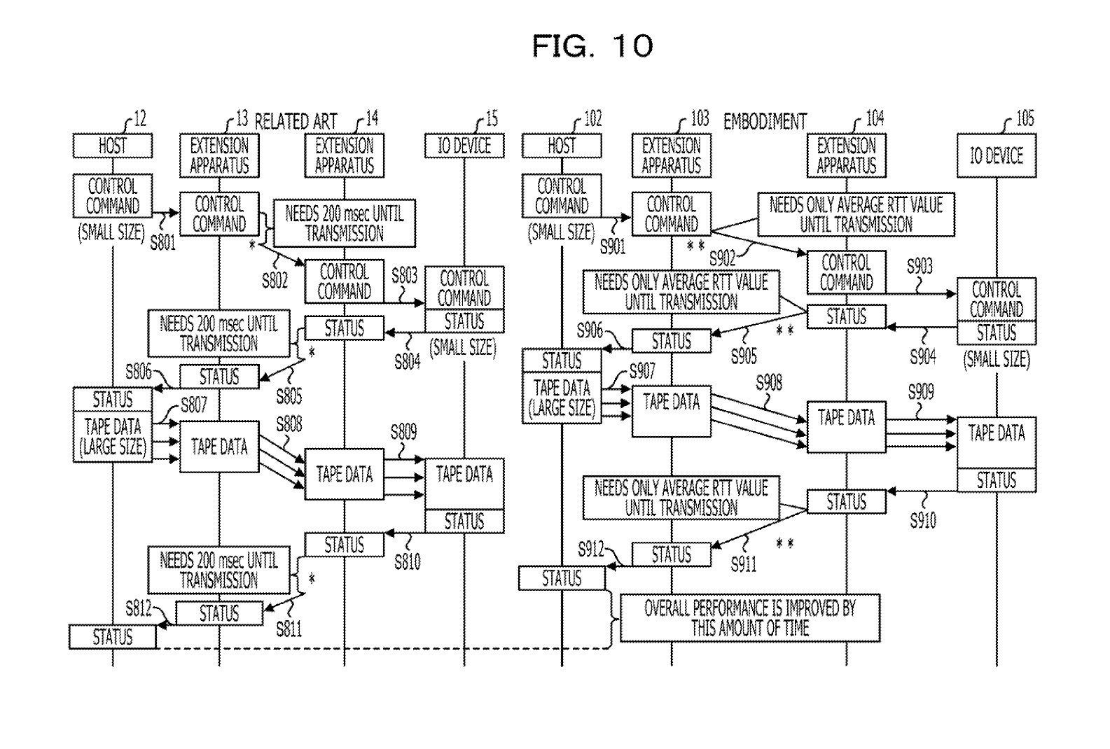

FIG. 10 is a data-write sequence diagram in the embodiment.

The left side in FIG. 10 is a data-write sequence diagram in the related-art technique, and the right side is a data-write sequence diagram in the embodiment.

FIG. 10 illustrates a sequence when a host writes data into an IO device.

Here, the IO devices 15 and 105 are assumed to be tape devices.

In the related-art technique, first, the host 12 transmits a control command to the channel extension apparatus 13 (S801), the channel extension apparatus 13 transmits the control command to the channel extension apparatus 14 (S802), and the channel extension apparatus 14 transmits the control command to the IO device 15 (S803).

The IO device 15 transmits a response to the control command, that is to say, a status (for example, write preparation OK) to the channel extension apparatus 14 (S804), the channel extension apparatus 14 transmits the status to the channel extension apparatus 12 (S805), and the channel extension apparatus 13 transmits the status to the host 12 (S806).

The host 12 transmits tape data to the channel extension apparatus 13 (S807), the channel extension apparatus 13 transmits the tape data to the channel extension apparatus 14 (S808), and the channel extension apparatus 14 transmits the tape data to the IO device 15 (S809). And the IO device 15 writes the tape data.

After completion of writing, the IO device 15 transmits a status stating write completion to the channel extension apparatus 14 (S810), the channel extension apparatus 14 transmits the status to the channel extension apparatus 12 (S811), and the channel extension apparatus 13 transmits the status to the host 12 (S812).

In the embodiment, first, the host 102 transmits a control command to the channel extension apparatus 103 (S901), the channel extension apparatus 13 transmits the control command to the channel extension apparatus 104 (S902), and the channel extension apparatus 104 transmits the control command to the IO device 105 (S903).

The IO device 105 transmits a response to the control command, that is to say, a status (for example, write preparation OK) to the channel extension apparatus 104 (S904), the channel extension apparatus 104 transmits the status to the channel extension apparatus 102 (S905), and the channel extension apparatus 103 transmits the status to the host 102 (S906).

The host 102 transmits tape data to the channel extension apparatus 103 (S907), the channel extension apparatus 103 transmits the tape data to the channel extension apparatus 104 (S908), and the channel extension apparatus 104 transmits the tape data to the IO device 105 (S909). And the IO device 105 writes the tape data.

After completion of writing, the IO device 105 transmits a status stating write completion to the channel extension apparatus 104 (S910), the channel extension apparatus 104 transmits the status to the channel extension apparatus 102 (S911), and the channel extension apparatus 103 transmits the status to the host 102 (S912).

In FIG. 10, the sizes of the control command and the status are assumed to be the MSS or less, and the size of tape data is assumed to be greater than the MSS.

In the related-art technique in FIG. 10, the Nagle algorithm is used for the communication between the channel extension apparatuses 13 and 14.

Accordingly, in the transmission of the control command in S802, and the transmission of the status in S805 and S811, that are denoted by * in the related-art technique, it takes 200 milliseconds from detection to transmission of a control command or a status.

The transmission of the control command in S902, and the transmission of the status in S905 and S911 (illustrated in FIG. 10), that are denoted by ** in the embodiment, an average RTT value is sufficient for waiting time from detection of a control command or a status to transmission.

Normally RTT is about 50 milliseconds at a maximum in Japan. And thus, the average RTT value becomes smaller than 200 milliseconds.

Accordingly, in the embodiment, transmission waiting time for a control command and a status that are transmitted between the channel extension apparatuses is shortened compared with that of a related art. Thereby, overall data-write processing time is shortened.

By a channel extension apparatus according to the embodiment, transmission waiting time for small-sized data between the extension apparatuses decreases, and thus data-write time from the host to the IO device is shortened.

By a channel extension apparatus according to the embodiment, it is possible to shorten transmission intervals between small-sized data by performing transmission schedule control on the basis of RTT. In particular, in the case where small-sized data and large-sized data are mixed, it is possible to maintain data transmission intervals to be a desired interval while keeping transfer efficiency of large-sized data unchanged. As a result, it becomes possible to perform a series of data transfer at a high speed.

Also, by a channel extension apparatus according to the embodiment, an RTT is measured periodically to calculate an average RTT value, and transmission control is performed using the RTT average value as desired transmission timing at that point in time. Thereby, even if a delay temporarily becomes large because of network congestion, the RTT average value does not change in an overreacting manner. Accordingly, it becomes possible to maintain stable transfer performance.

Also, a channel extension apparatus according to the embodiment has a function of comparing the measured RTT with an allowable value, and not using an RTT greater than the allowable value for calculation of the RTT average value. Thereby, even if a large delay occurs unexpectedly and temporarily by a problem of network devices scattered over among channel extension apparatuses, etc., the RTT average value does not change, and thus transfer performance will not be deteriorated.

By the above-described effects, in remote data transfer between a host computer and IO devices through channel extension apparatuses, even if small-sized data, such as a control command and a status, and large-sized data, such as tape data and print data are mixed together, it is possible to reduce a decrease in efficiency of transmission waiting time of small-sized data, and to improve communication performance of an overall system.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiment(s) of the present invention has(have) been described in detail, it should be understood that the various changes, substitutions, and alterations could be made hereto without departing from the spirit and scope of the invention.

What is claimed is:

1. A relay apparatus performing communication between a first processing apparatus and a second processing apparatus through another relay apparatus, the relay apparatus comprising:
a transmission unit to transmit transmission data to the other relay apparatus;
a calculation unit to measure a round trip time (RTT) from transmission of data to the other relay apparatus to receiving of a response, and calculate transmission time on a basis of the measured RTT; and
a scheduler unit to control transmission times of transmission data to the other relay apparatus outputs, when the scheduler unit detects the transmission data and a size of the detected transmission data is not larger than a specified value, the transmission data to the transmission unit after a time from the detection of the transmission data has passed the transmission time.

2. The relay apparatus according to claim 1,
wherein the specified value is a maximum segment size of a transmission control protocol.

3. The relay apparatus according to claim 1,
wherein the calculation unit calculates an average value of a plurality of the measured RTTs as the transmission time.

4. The relay apparatus according to claim 1,
wherein the calculation unit measures the RTT periodically.

5. The relay apparatus according to claim 1,
wherein when the RTT is larger than an allowable value, the calculation unit does not use the RTT to calculate the transmission time.

6. A relay apparatus performing communication between a first processing apparatus and a second processing apparatus through another relay apparatus, the relay apparatus comprising:
a memory configured to store transmission data to be transmitted to the other relay apparatus; and
a processor configured to execute a procedure, the procedure comprising:
measuring a round trip time (RTT) from transmission of data to the other relay apparatus to receiving of a response;
calculating a transmission time on a basis of the RTT; and
transmitting, when the transmission data is detected and a size of the detected transmission data is not larger than a specified value, the transmission data to the other relay apparatus after a time from the detection of the transmission data has passed the transmission time.

7. A method of communication between a first processing apparatus and a second processing apparatus through another relay apparatus performed by a relay apparatus, the method comprising:
measuring a round trip time (RTT) from transmission of data to the other relay apparatus to receiving of a response;
calculating a transmission time on a basis of the RTT; and
transmitting, when the transmission data to be transmitted to the other relay apparatus is detected and a size of the detected transmission data is not larger than a specified value, the transmission data to the other relay apparatus after a time from the detection of the transmission data has passed the transmission time.

8. The method of communication according to claim 7,
wherein the specified value is a maximum segment size of a transmission control protocol.

9. The method of communication according to claim 7,
wherein an average value of a plurality of the RTTs is calculated as the transmission time in processing for calculating the transmission time.

10. The method of communication according to claim 7,
wherein the RTT is measured periodically.

11. The method of communication according to claim 7,
wherein when the RTT is larger than an allowable value, the RTT is not used for calculating the transmission time.
